(19) United States
(12) Patent Application Publication
(10) Pub. No.: US 2003/0200247 A1
(43) Pub. Date: Oct. 23, 2003

(54) Server computer and a method for accessing resources from virtual machines of a server computer via a fibre channel

(75) Inventors: Gerhard Banzhaf, Nufringen (DE); Ralph Friedrich, Sindelfingen (DE); Stefan Mueller, Holzgerlingen (DE); Christoph Raisch, Gerlingen (DE)

Correspondence Address: IBM Corporation, Intellectual Property Law, 2455 South Road, P386, Poughkeepsie, NY, 12601, US

(73) Assignee: International Business Machines Corporation, Armonk, NY

(21) Appl. No.: 10/353,591

(22) Filed: Jan. 29, 2003

(30) Foreign Application Priority Data
Feb. 2, 2002 (EP) 02002497.2

(51) Int. Cl. G06F 17/00

(52) U.S. Cl. 709/1

(57) ABSTRACT

The invention relates to a server computer having a plurality of virtual machines which share the same fibre channel PCI adapter for communication over a fibre channel and a corresponding method for accessing a resource from a virtual machine comprising the steps of sending a request from the virtual machine together with a request identifier to an adapter component of the server computer, transforming the identifier into an unequivocal identifier of the request, transmitting the request with the unequivocal identifier over a fibre channel to the resource, receiving a response from the resource with an unequivocal identifier of the response, and forwarding the response to the corresponding virtual machine.

### BACKGROUND OF THE INVENTION

The present invention relates to the field of communication over the fibre channel, and more particularly to sending of requests for resources from virtual machines over the fibre channel.

Fibre channel is a high speed, full-duplex, serial communications technology used to interconnect input/output (I/O) devices and host systems that can be separated by tens of kilometers. It incorporates the best features of traditional I/O interfaces, like throughput and reliability found in SCSI and PCI, with the best features of networking interfaces, like connectivity and scalability found in Ethernet and Token Ring. It provides a transport mechanism for the delivery of existing commands, and provides an architecture that achieves high performance by allowing a significant amount of processing to be performed in hardware. It can operate with legacy protocols and drivers like SCSI and IP, enabling it to be introduced easily into existing infrastructures.

Fibre channel transfers information between the sources and the users of the information. This information can include commands, controls, files, graphics, video and sound. Fibre channel connections are established between Fibre channel ports residing in I/O devices, host systems, and the network interconnecting them. The network consists of elements like switches, hubs, bridges and repeaters that are used to interconnect the fibre channel ports.

There are three fibre channel topologies defined in the fibre channel architecture. These are Point-to-Point, Switched Fabric and Arbitrated Loop.

Fibre channel switches (or switched fabrics) also include a function commonly called Zoning. This function allows the user to partition the switch ports into port groups. The ports within a port group, or zone, can only communicate with other ports in the same port group (zone). By using zoning, the I/O from one group of hosts and devices can be completely separated from that of any other group, thus preventing the possibility of any interference between the groups.

The way this zoning works is that the user assigns nodes to a zone according to the node's World Wide Name—either the World Wide Port Name (WWPN) or the World Wide Node Name (WWNN). This information is captured by the name server, which is a function embedded within the switch. Then, whenever a port communicates with the name server to find out to which nodes it is allowed to connect, the name server will respond only with the nodes that are within that port's zone.

Since the standard fibre channel device drivers do communicate with the name server in this manner, this type of zoning is adequate for most situations. However, it is possible that a device driver could be designed that would attempt to access nodes not in its list of allowed connections. If this occurred, the switch would neither prevent nor detect the violation.

Fibre channel Storage Area Networks (SANs) are networks that connect storage devices to host servers. They are built upon the fibre channel technology as a networking infrastructure. What differentiates SANs from previous interconnection schemes is the basic concept that all (or mostly all) of the storage can be consolidated in one large “storage area” that allows centralized (simplified) management in addition to any-to-any connectivity between host servers and the storage.

Fibre channel SANs have the potential to allow the interconnection of open systems and storage (i.e., non-S/390) in the same network as S/390 systems and storage. This is possible because the protocols for both open attachment and S/390 attachment are being mapped to the FC-4 layer of the fibre channel architecture.

In fibre channel attachments, LUNs have an affinity to the host's fibre channel adapter (via the adapter's World Wide Unique Identifier, a.k.a. the World Wide Port Name), independent of which ESS (IBMs Enterprise Storage Server) fibre channel port the host is attached to. Therefore, in a switched fabric configuration where a single fibre channel host can have access to multiple fibre channel ports on the ESS, the setz of LUNs which may be accessed by the fibre channel host are the same on each of the ESS ports.

One result of this implementation is that with fibre channel, unlike in SCSI, hosts that are attached to ESS via a fabric to the same fibre channel port may not be able to “see” the same LUNs, since the LUN masking can be different for each fibre channel host. In other words, each ESS can define which host has access to which LUN.

Another method is to create zones in the switch such that each fibre channel port from each host is constrained to attach to one fibre channel port on the ESS, thereby allowing the host to see the LUNs via one path only.

Details of the fibre channel specification are shown in the following standards: fibre channel Physical and Signaling Interface (FC-PH), ANSI X3.230-1994; fibre channel Second Generation Physical Interface (FC-PH-2), ANSI X3.297-1997; fibre channel Third Generation Physical Interface (FC-PH-3), ANSI X3.303-199X, Revision 9.4 and fibre channel Arbitrated Loop (FC-AL), ANSI X3.272-1996. Further relevant standards are FC-FS, FC-GS-3.

Further information concerning the fibre channel is disclosed in The fibre channel Consultant—A Comprehensive Introduction (Robert W. Kembel, 1998) and The fibre channel Consultant—Arbitrated Loop (Robert W. Kembel, 1996).

U.S. Pat. No. 6,173,374 shows a system and method for peer-to-peer accelerated I/O shipping between host bus adapters in clustered computer network. Signals associated with the bus of the host computer system are exchanged with a bus specific to the I/O device (e.g. fibre channel).

U.S. Pat. No. 6,061,349 shows a system for handling a plurality of connection requests made for a plurality of virtual machines with a single physical machine. The system serves to distribute virtual connections among a plurality of physical machines some or all of which are configured to handle connections for more than one virtual machine. A packet translation system for handling connections from clients on an external network to a plurality of IP addresses with a server having a server IP address and a server port number includes a client interface to the external network. The client interface is operative to receive and send packets to and from a remote client. A server interface is operative to receive and send packets to and from the server and the server is operative to establish a connection with the remote client. A packet interceptor is operative to intercept incoming packets received at the client interface which have a packet destination IP address and a packet destination port number corresponding to a virtual machine IP address and a virtual machine port number which is supported by the packet translation system. A packet header translator is operative to translate the packet destination IP address and the packet destination port number of packets forwarded by the packet interceptor to a physical machine IP address and a physical machine port number that corresponds to the server IP address and the server port number of the server. The server Port runs a real process corresponding to a virtual process simulated on the virtual port number. As a result, the packet translation system receives packets at the client interface and the packet destination IP address sand the packet destination port number corresponding to the virtual machine IP address and the virtual machine port number are translated to the server IP address and the server port number and the packets are forwarded to the server via the server interface.

It is a substantial disadvantage of this prior art system that there is a 1:1 relationship for each client-server connection, i.e. each individual connection remains identifiable and must be administrated by all involved devices. This means that each of the clients needs to administer each of the connections, even connections which belong to other clients.

In essence the prior art allows to provide one ore more fibre channel adapters for dedicated access of one virtual machine. However, it is a common disadvantage of the prior art that a plurality of virtual machines can not share the same physical fibre channel adapter.

### SUMMARY OF THE INVENTION

The present invention provides an improved server computer and an improved method for accessing a resource over a fibre channel. Further the invention provides an improved computer system and an improved computer program product.

Briefly the present invention allows a number of virtual machines of a server computer to share the same fibre channel adapter for accessing of system resources. Virtualizing a fibre channel host bus adapter (HBA) is a unique feature provided by the present invention. This solution requires no changes in end-point devices like disk controllers.

In accordance with a preferred embodiment of the invention the virtual machines can have the same or different operating systems, such as VM/ESA or OS/390.

In accordance with a further preferred embodiment of the invention the server computer comprises an adapter component for access rights administration. In one implementation the access rights administration module contains a table for assigning of access rights for each individual machine.

The content of the table can be modified by means of a control interface module. The control interface module can be coupled to one of the virtual machines of the server computer. This one virtual machine has administrative purposes and has exclusive access to the control interface module. All other virtual machines have no access path to the control interface module or the access rights administration module. Preferably for the purposes of fail-over support one or more additional virtual machines with access rights to the control interface module can be provided.

In accordance with a further preferred embodiment of the invention the adapter component of the server computer comprises a transformation module for transformation of an unequivocal identifier of a response of a resource. By means of the transformation the corresponding request and the corresponding virtual machine from which the request originate are identified.

It is a particular advantage of the present invention that it allows to independently rent or lease virtual machines on a server computer. The access rights of each customer are configured by means of the administration virtual machine and the control interface. The same fibre channel adapter can be used by a number of virtual machines for sharing of system resources over the fibre channel.

### BRIEF DESCRIPTION OF THE DRAWINGS

These and other objects will be apparent to one skilled in the art from the following detailed description of the invention taken in conjunction with the accompanying drawings in which:

FIG. 1 is a schematic block diagram of a preferred embodiment of a computer system in accordance with the invention, and

FIG. 2 is a illustrative of a flow chart of an embodiment of a method in accordance with the invention.

### DESCRIPTION OF THE PREFERRED EMBODIMENT

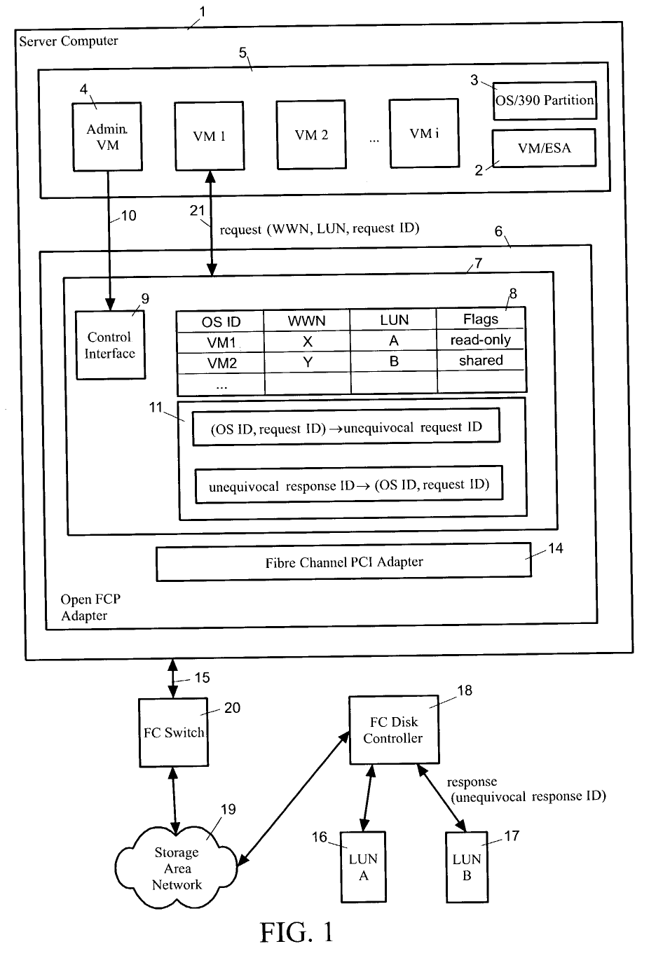

FIG. 1 shows a block diagram of an embodiment of a computer system in accordance with the invention. The computer system comprises a server computer 1. The server computer 1 has one or more operating systems such as VM/ESA 2 or OS/390 3. By means of such operating systems a number of virtual machines VM 1, VM 2, VM . . . , VM i can be realized as well as a dedicated administration virtual machine 4. This way a virtual machine component 5 is realized.

Further the server computer 1 has an adapter component 6. The adapter component 6 comprises an access right administration module 7. The access rights administration module 7 has a table 8 for storage of access rights of individual virtual machines. The first column of the table 8 contains the identifiers of the operating systems. The second column contains the World Wide Names of resources such as target devices which can be accessed, the third column contains the LUNs of the target devices, and the fourth column contains flags for specifying access rights, such as read-only, read-write or shared. Further the table 8 can contain one or more additional columns for specifying the adapter and bandwith resources which are available for each virtual machine.

Further the access right administration module 7 has a control interface 9. The administration virtual machine 4 can be coupled to the control interface 9 in order to write information into table 8, such as for registering a new virtual machine, and to read or modify access rights of virtual machines which are already registered.

It is important to note that only the administration virtual machine 4 has a channel 10 for coupling to the control interface 9. This way it is prevented that unauthorized users of other virtual machines VM 1, VM 2, VM . . . , VM i read or modify access rights. This is an important advantage as typically the billing for leasing or renting of a virtual machine depends on the extent of access rights being granted to that virtual machine.

The access right administration module 7 further has a transformation module 11. The transformation module 11 has a function 12 for transforming a 2-tuppel containing the identifier of the virtual machine and a request identifier into an unequivocal request identifier.

The transformation module 11 has a function 13 for transforming an unequivocal identifier of a response back to the 2-tuppel. This way the destination of a response received over the fibre channel is identified.

Further the server computer 1 has a fibre channel PCI adapter 14. The fibre channel PCI adapter 14 serves as a common access point of the server computer 1 to a fibre channel 15.

In the example considered here, the disk 16 and the disk 17 can be accessed from the fibre channel PCI adapter 14. The disk 16 has the Logical Unit Number (LUN) A and the disk 17 has the LUN B. The disks 16 and 17 are coupled to fibre channel disk controller 18 which is coupled to Storage Area Network (SAN) 19. The Storage Area Network 19 is coupled to fibre channel switch 20. The fibre channel switch 20 is connected to the fibre channel 15.

In operation anyone of the virtual machines VM 1, VM 2, . . . VM i can issue a request for accessing a system resource such as disk 16 or disk 17. A corresponding request specifies the type of the desired operation, for example read or write, and it specifies the address of the desired target device.

In the example considered here, the address is defined by the World Wide Name of the target device and its LUN. The World Wide Name (WWN) can be a World Wide Port Name (WWPN) or a World Wide Node Name (WWNN). Further the request has an identifier which is assigned to the request by the requesting virtual machine. The identifier of the request belongs to a number space which is not necessarily unique to the requesting virtual machine.

In other words the virtual machines VM 1, VM 2, . . . , VM i can have the same number space or overlapping number spaces for assigning identifiers to their respective request. This has the advantage that additional complexity for defining a mechanism of separate number spaces can be avoided. This way the virtual machines VM 1, VM 2, . . . , VM i can operate completely independently.

In the example considered here the virtual machine VM 1 sends a request in the form request (WWN, LUN, request ID) via a channel 21 to the access right administration module 7. The channel 21 is established within server computer 1 between the VM 1 and the access right administration module 7. For example, the VM 1 requires a write operation to the disk 16.

In this case the request specifies the WWN of X (this is the WWN of the fibre channel disk control of the disk 16) and the LUN=A (this is the LUN of the disk 16). Further the request contains a request ID which is automatically assigned by the virtual machine VM 1 from its number space for request Ids.

This request of virtual machine VM 1 is intercepted by the access right administration module 7. The table 8 is accessed in order to check if the access rights given to the virtual machine VM 1 from which the request is issued are sufficient to grant access to the desired target device—which is disk 16.

In the example considered here, the corresponding entry in the table 8 for the virtual machine VM 1 has a read-only flag. This means that the desired write access is not possible and a corresponding message is provided from the access right administration module 7 back to the virtual machine VM 1 via channel 21.

By way of example it is assumed that virtual machine VM 1 issues a following request for a read-only operation on disk 16. This request is granted as the rights specified in the table 8 are sufficient for the virtual machine VM 1 for this kind of request.

In this case the identifier of the virtual machine VM 1 and the identifier of its request are transformed into an unequivocal request identifier by the function 12 of transformation module 11. By means of this mapping operation potential ambiguities of the request identifiers due to overlapping number spaces of the virtual machines VM 1, VM 2, . . . VM i are removed.

The corresponding request together with the unequivocal request ID is then sent from the fibre channel PCI adapter 14 on to the fibre channel 15. The request reaches the disk 16 via the fibre channel Switch 20, the Storage Area Network 19 and the fibre channel Disk Controller 18.

As a response the disk 16 provides data in accordance with the read request. These data are transmitted from the disk 16 back to the server computer 1 via the fibre channel disk controller 18, the Storage Area Network 19, the fibre channel switch and fibre channel 19. The response contains an unequivocal identifier. This identifier can be the same as the unequivocal identifier of the request or it can be another identifier.

The response is received by the fibre channel PCI adapter 14 and provided to the transformation module 11. By means of function 13 of transformation module 11 the 2-tupel consisting of the identifier of the requesting virtual machine and the identifier of the request are determined. This way the channel 21 is identified as a communication path for forwarding the response of the disk 16 to the requesting virtual machine VM 1.

As part of the response the virtual machine VM 1 also receives data indicative of the original request identifier. This enables the virtual machine VM 1 to recognize the data of the response as the desired data read from the disk 16.

It is to be noted that the above-described mechanism is applicable with respect to all virtual machines VM 1, VM 2, . . . , VM i and can be performed in parallel on the server computer 1. Further it is important to note, that it is not essential to implement the administrator virtual machine 4 within the virtual machine component 5 of the server computer 1.

Rather the administration virtual machine 4 can be implemented on any other computing element in a network provided that this computing element has a trusted access path to the server computer 1. Only via this trusted path and instance a modification of the access right table 8 is possible to prevent tempering from other users.

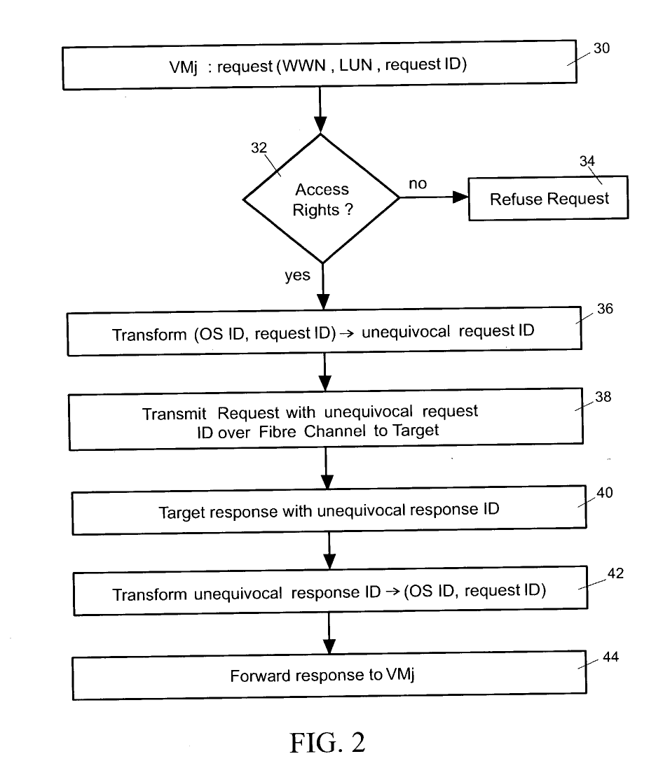

FIG. 2 shows a corresponding flow chart. In step 30 one of the virtual machines VMj issues a request for a system resource specifying the WWN, LUN and a operating system specific request identifier.

In step 32 it is checked whether the access rights of the virtual machine VMj are sufficient for the request of step 30. If this is not the case the request is refused in step 34 and a corresponding message is provided to the virtual machine Vmj.

If the access rights are sufficient, step 36 is performed in order to determine an unequivocal identifier of the request which is not specific for the virtual machine VMj having issued the request. Such an unequivocal request identifier is obtained by means of a transformation function which transforms the 2-tuppel containing the identifier of the virtual machine VMj and the identifier of the request which has been assigned by the virtual machine Vmj.

In step 38 the request and the unequivocal request identifier are transmitted over a fibre channel to the target resource. In step 40 the target resource responds to the request. The response has an associated unequivocal response identifier. In a preferred embodiment the unequivocal response identifier is the same as the unequivocal request identifier. However, the unequivocal response identifier can also be different from the unequivocal request identifier as long as a one-to-one relationship resists between the identifiers.

When the response with the unequivocal response identifier is received in step 42 the transformation of step 36 is reversed in order to obtain the original 2-tuppel. In step 44 the response with the original request identifier is forwarded to the virtual machine Vmj.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A server computer comprising:
a virtual machine component providing a number of virtual machines (Vmi),
an adapter component having a transformation module transforming an identifier of a request of one of the virtual machines for access to a resource to an unequivocal identifier of the request, and
a fibre channel module sending the request with the unequivocal identifier to the resource via a fibre channel.

2. The server computer of claim 1 wherein the virtual machines have the same or different operating systems such as VM/ESA or OS/390.

3. The server computer of claims 1 wherein the adapter component further comprises an access rights administration module for assigning of access rights to the virtual machines.

4. The server computer of claim 1 further comprising a control interface module for entering of access rights into the access rights administration module, the control interface module being adapted to be coupled to a dedicated administrator virtual machine via a dedicated channel.

5. The server computer of anyone of claim 1 wherein the transformation module is adapted to receive an unequivocal identifier of a response of the resource and to identify the corresponding request of one of the virtual machines in order to forward the response to that virtual machine.

6. A computer system comprising a server computer having a virtual machine component providing a number of virtual machines (Vmi), an adapter component having a transformation module transforming an identifier of a request of one of the virtual machines for access to a resource to an unequivocal identifier of the request, and a fibre channel module sending the request with the unequivocal identifier to the resource via a fibre channel;
a fibre channel switch coupled to the server computer;
a Storage Area Network coupled to the fibre channel switch; and 1a fibre channel resource controller coupled to the resource and to the Storage Area Network.

7. A method for accessing a resource from a virtual machine of a plurality of virtual machines being provided by a server computer, the method comprising the steps of:
sending a request from the virtual machine together with a request identifier to an adapter component of the server computer,
transforming the identifier into an unequivocal identifier of the request,
transmitting the request with the unequivocal identifier over a fibre channel to the resource,
receiving a response from the resource with an unequivocal identifier of the response, and
forwarding the response to the corresponding virtual machine.

8. The method of claim 7 further comprising identifying the virtual machine and the request by means of the unequivocal identifier of the response.

9. The method of claim 7 wherein the unequivocal identifier of the response is the same as the unequivocal identifier of the request.

10. A computer program product for accessing a resource from a virtual machine of a plurality of virtual machines being provided by a server computer, the program product comprising:
a computer readable medium having recorded thereon computer readable program code performing the method comprising:
sending a request from the virtual machine together with a request identifier to an adapter component of the server computer,
transforming the identifier into an unequivocal identifier of the request,
transmitting the request with the unequivocal identifier over a fibre channel to the resource,
receiving a response from the resource with an unequivocal identifier of the response, and
forwarding the response to the corresponding virtual machine.

11. The program product of claim 10 wherein the method further comprises identifying the virtual machine and the request by means of the unequivocal identifier of the response.

12. The program product of claim 10 wherein the unequivocal identifier of the response is the same as the unequivocal identifier of the request.
